(19) United States
(12) Patent Application Publication
(10) Pub. No.: US 2025/0220460 A1
(43) Pub. Date: Jul. 3, 2025

(54) METHOD AND DEVICE FOR CONFIGURING MEASUREMENT GAP

(71) Applicant: Beijing Xiaomi Mobile Software Co., Ltd., Beijing (CN)

(72) Inventors: Ziquan HU, Beijing (CN); Xuhua TAO, Beijing (CN)

(21) Appl. No.: 18/881,657

(22) PCT Filed: Jul. 8, 2022
(86) PCT No.: PCT/CN2022/104762

§ 371 Date: Jan. 6, 2025

(51) Int. Cl. H04W 24/02; H04L 5/00; H04W 76/20

(52) U.S. Cl. CPC H04W 24/02; H04L 5/0053; H04W 76/20

(57) ABSTRACT

A method for configuring a measurement gap, performed by a terminal, the method including: receiving measurement gap configuration information transmitted from a first network, and measuring, in response to satisfying a preset measurement condition, a second network according to the measurement gap configuration information.

### CROSS-REFERENCE TO RELATED APPLICATIONS

The present application is a U.S. National Stage of International Application No. PCT/CN2022/104762, filed on Jul. 8, 2022, the contents of all of which are incorporated herein by reference in their entireties for all purposes.

### BACKGROUND OF THE INVENTION

In a communication scene of a multi-universal subscriber identity module (MUSIM), terminal, for example, user equipment (UE), supporting a MUSIM ability can be simultaneously connected to two networks. However, terminal capable of single transmit (single TX)/single receive (single RX) or single TX/dual receive (dual RX) cannot simultaneously maintain radio resource control (RRC) connection with two networks because it merely has a single TX ability. In a case where a first network is in a connected state and a second network is in an idle or inactive state, measurement gap information needs to be configured, such that signal quality of the second network can be measured based on the measurement gap information.

### SUMMARY OF THE INVENTION

The present disclosure relates to the technical field of communication, and particularly relates to a method and device for configuring a measurement gap.

A method for configuring a measurement gap is provided according to an example of a first aspect of the present disclosure. The method is performed by a terminal. The method includes: receiving measurement gap configuration information transmitted from a first network; and measuring, in response to satisfying a preset measurement condition, a second network according to the measurement gap configuration information.

A method for configuring a measurement gap is provided according to an example of a second aspect of the present disclosure. The method is performed by a first network. The method includes: transmitting measurement gap configuration information to a terminal.

A system for configuring a measurement gap is provided according to an example of a third aspect of the present disclosure. The system includes: a terminal and a first network. The first network transmits measurement gap configuration information to the terminal; and the terminal receives the measurement gap configuration information transmitted from the first network and measure a second network according to the measurement gap configuration information in a case where a preset measurement condition is satisfied.

A communication device is provided according to an example of a fourth aspect of the present disclosure. The communication device includes: a transceiver; a memory; and a processor connected to the transceiver and the memory separately, where the processor is configured to control the transceiver to transceive radio signals by executing a computer-executable instructions in the memory to implement the method according to the example of the first aspect or the second aspect of the disclosure.

A non-transitory computer storage medium is provided according to an example of a fifth aspect of the present disclosure. The non-transitory computer storage medium stores a computer-executable instructions. The computer-executable instructions, when executed by a processor, implements the method according to the example of the first aspect or the second aspect of the present disclosure after being executed by a processor.

Additional aspects and advantages of the present disclosure will be set forth partially in the following description, which will become obvious in the following description, or will be learned by practice of the present disclosure.

### BRIEF DESCRIPTION OF DRAWINGS

The aspects and/or additional aspects and advantages of the present disclosure will become obvious and comprehensible from the description of examples in conjunction with the accompanying drawings below.

FIG. 1 is a schematic flow diagram of a method for configuring a measurement gap according to an example of the present disclosure;

FIG. 2 is a schematic flow diagram of a method for configuring a measurement gap according to an example of the present disclosure;

FIG. 3 is a schematic flow diagram of a method for configuring a measurement gap according to an example of the present disclosure;

FIG. 4 is a schematic diagram of a configuration mode according to an example of the present disclosure;

FIG. 5 is a schematic flow diagram of a method for configuring a measurement gap according to an example of the present disclosure;

FIG. 6 is a schematic flow diagram of a method for configuring a measurement gap according to an example of the present disclosure;

FIG. 7 is a schematic flow diagram of a method for configuring a measurement gap according to an example of the present disclosure;

FIG. 8 is a sequence diagram of a method for configuring a measurement gap according to an example of the present disclosure;

FIG. 9 is a block diagram of a device for configuring a measurement gap according to an example of the present disclosure;

FIG. 10 is a block diagram of a device for configuring a measurement gap according to an example of the present disclosure;

FIG. 11 is a schematic structural diagram of a communication device according to an example of the present disclosure; and

FIG. 12 is a schematic structural diagram of a chip according to an example of the present disclosure.

### DETAILED DESCRIPTION OF THE INVENTION

Examples of the present disclosure will be described in detail below. Instances of the examples are shown in accompanying drawings, throughout which identical or similar reference numerals denote identical or similar elements or elements having identical or similar functions. The examples described with reference to the accompanying drawings are illustrative and merely intended to explain the present disclosure, instead of being construed as limiting the present disclosure. It is to be noted that the examples in the present disclosure and features in the examples can be combined with one another in a case where there is no conflict.

The terms used in the examples of the present disclosure are merely to describe the specific examples, instead of limiting the examples of the present disclosure. The singular forms such as “a”, “an” and “the” used in the examples of the present disclosure and the appended claims are also intended to include the plural forms, unless otherwise clearly stated in the context. It is to be further understood that the term “and/or” used here refers to and includes any of one or more of the associated listed items or all possible combinations.

It is to be understood that although the terms such as first, second and third may be used to describe various information in the examples of the present disclosure, the information is not to be limited to the terms. The terms are merely used to distinguish the same type of information from each other. For instance, without departing from the scope of the examples of the present disclosure, first information may also be referred to as second information, and similarly, second information may also be referred to as first information. Depending on the context, the word “if” used here can be interpreted as “when” or “at the time of” or “in response to determining”.

At present, the measurement gap information is generally configured and transmitted by the first network. The terminal can receive the measurement gap information and then measure the second network with the measurement gap information. When a second network is measured, data of a first network cannot be transmitted and received, and measurement gap information transmitted from the first network is fixed. In a case where the measurement gap information is configured irrationally, service performance of the first network is compromised.

In view of that, the example provides a method and a device for configuring a measurement gap, such that measurement gap information can be rationally configured to ensure service performance of a first network.

The method and the device for configuring a measurement gap according to the present disclosure will be described below in detail with reference to the accompanying drawings.

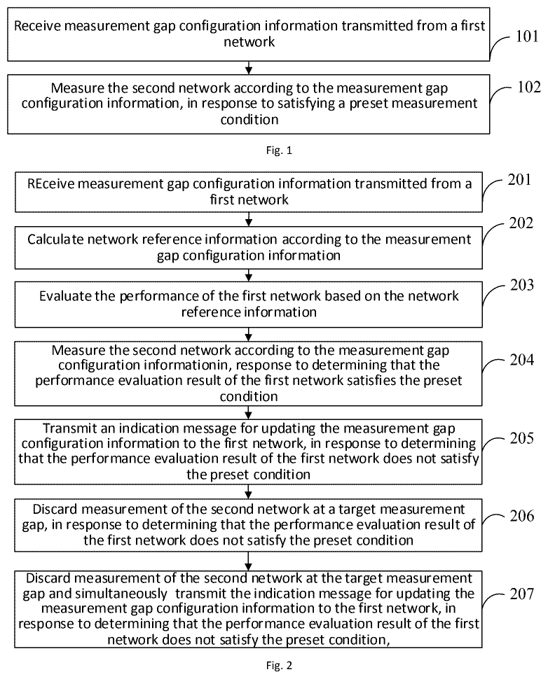

FIG. 1 shows a schematic flow diagram of a method for configuring a measurement gap according to an example of the present disclosure. As shown in FIG. 1, the method is performed by a terminal, for example, user equipment (UE). The method may include the following step 101 to step 102.

Step 101, measurement gap configuration information transmitted from a first network is received.

The terminal is multi-universal subscriber identity module (MUSIM) type terminal. That is, the terminal in the example of the present disclosure has a MUSIM ability, supports at least two card slots, and may be connected to at least two networks simultaneously. The terminal may receive the measurement gap configuration information with one configuration mode, two configuration modes, or more configuration modes. The measurement gap configuration information includes a measurement gap period, a measurement gap length, and a measurement gap offset. The measurement gap period includes at least one measurement gap length. In the measurement gap length, the terminal measures a second network. In this case, the first network cannot transmit and receive data. The measurement gap offset is starting time of the measurement gap length in one measurement gap period.

According to the example of the present disclosure, the first network of the terminal is in a connected state, and the second network of the terminal is in an idle state or an inactive state. In this scene, the first network may transmit pre-configured measurement gap configuration information with at least one configuration mode to the terminal. The terminal may measure signal quality of the second network based on the measurement gap configuration information after receiving the measurement gap configuration information.

Step 102, in response to satisfying a preset measurement condition, the second network is measured according to the measurement gap configuration information.

In order to avoid influence on service performance of the first network due to irrational measurement gap information configured by the first network, the terminal may determine whether the measurement gap configuration information satisfies the preset measurement condition after receiving the measurement gap configuration information transmitted from the first network. In a case where the measurement gap configuration information satisfies the preset measurement condition, it is indicated that performance of the first network cannot be influenced when the terminal measures the second network using the measurement gap configuration information. In a case where the measurement gap configuration information does not satisfy the preset measurement condition, it is indicated that performance of the first network can be influenced when the terminal measures the second network using the measurement gap configuration information. In this case, the terminal may report to the first network so as to inform the first network to update the measurement gap configuration information.

Through the method for configuring a measurement gap according to the example, the measurement gap configuration information transmitted from the first network may be received by the terminal, and in a case where the measurement gap configuration information satisfies the preset measurement condition, the second network may be measured by the terminal according to the measurement gap configuration information. Thus, rationality of the measurement gap configuration information can be ensured, and influence on data transceiving in the first network due to irrational measurement gap configuration information can be avoided, such that service performance and service continuity of the first network can be ensured.

FIG. 2 shows a schematic flow diagram of a method for configuring a measurement gap according to an example of the present disclosure. The method is performed by terminal. Based on the example shown in FIG. 1, as shown in FIG. 2, the method may include the following step 201 to step 207.

Step 201, measurement gap configuration information transmitted from a first network is received.

According to the example of the present disclosure, a process of obtaining the measurement gap configuration information is consistent with step 101, and is not repeated here.

Step 202, network reference information is calculated according to the measurement gap configuration information.

The network reference information may specifically be a network throughput. The network reference information in the example of the present disclosure may also be another piece of information, and is not specifically limited in the example of the present disclosure.

In the example of the present disclosure, in order to determine whether the measurement gap configuration information transmitted from the first network is rational, performance of the first network needs to be evaluated based on the measurement gap configuration information. In an evaluation process, the network reference information, for instance, the network throughput, may be calculated according to the measurement gap configuration information transmitted from the first network. Then, the performance of the first network may be evaluated based on the network reference information. Specifically, when the network reference information is calculated, the network reference information (the network throughput) may be determined according to a measurement gap period, a measurement gap length and a measurement gap offset in the measurement gap configuration information.

Step 203, the performance of the first network is evaluated based on the network reference information.

According to the example of the present disclosure, whether a performance evaluation result of the first network satisfies a preset condition may be determined according to the calculated network reference information, and for instance, the network throughput. In a case where the performance evaluation result of the first network satisfies the preset condition, it is indicated that the performance of the first network cannot be influenced when the second network is measured with the measurement gap configuration information transmitted from the first network. In a case where the performance evaluation result of the first network does not satisfy the preset condition, it is indicated that the performance of the first network can be influenced when the second network is measured with the measurement gap configuration information transmitted from the first network.

Step 204, in response to determining that the performance evaluation result of the first network satisfies the preset condition, the second network is measured according to the measurement gap configuration information.

According to the example of the present disclosure, in a case where the performance evaluation result of the first network satisfies the preset condition, it is indicated that the performance of the first network cannot be influenced when the second network is measured with the measurement gap configuration information transmitted from the first network. In this case, the terminal may measure signal quality of the second network with the measurement gap configuration information.

Step 205 parallel to step 204, in response to determining that the performance evaluation result of the first network does not satisfy the preset condition, an indication message for updating the measurement gap configuration information is transmitted to the first network. The indication message may include a UAI message or an RRC message.

The UAI message may include at least one of: an indication of poor signal quality of the current first network or the measurement gap configuration information preferred by the terminal for the second network.

According to the example of the present disclosure, in a case where the performance evaluation result of the first network does not satisfy the preset condition, it is indicated that the performance of the first network can be influenced when the second network is measured with the measurement gap configuration information transmitted from the first network. In this case, the terminal may transmit the indication message for updating the measurement gap configuration information to the first network. The first network may update the previously transmitted measurement gap configuration information after receiving the indication message. The first network may re-transmit the updated measurement gap configuration information to the terminal. The terminal continues to evaluate the performance of the first network based on the updated measurement gap configuration information.

Step 206 parallel to step 204, in response to determining that the performance evaluation result of the first network does not satisfy the preset condition, measurement of the second network at a target measurement gap is discarded.

The target measurement gap is any measurement gap in the measurement gap period.

According to the example of the present disclosure, in response to determining that the performance evaluation result of the first network does not satisfy the preset condition, the terminal may not only transmit the indication message for updating the measurement gap configuration information to the first network, but also may actively discard measurement of the second network at some measurement gaps. For instance, the measurement gap period of measurement configuration information includes two measurement gaps, that is, measurement gap 1 and measurement gap 2. The terminal normally measures the second network in both the measurement gap 1 and the measurement gap 2. However, as a current performance evaluation result of the first network does not satisfy the preset condition, the terminal may actively discard measurement of the second network at the measurement gap 2, such that data transceiving time of the first network is extended to ensure service performance of the first network.

Step 207 parallel to step 204, in response to determining that the performance evaluation result of the first network does not satisfy the preset condition, measurement of the second network at the target measurement gap is discarded, and simultaneously the indication message for updating the measurement gap configuration information is transmitted to the first network.

According to the example of the present disclosure, in order to further ensure the service performance of the first network, in response to determining that the performance evaluation result of the first network does not satisfy the preset condition, the terminal may simultaneously execute operations as follows: the indication message for updating the measurement gap configuration information is transmitted to the first network, and measurement of the second network at some measurement gaps is discarded.

Through a precoding method provided by the example, the terminal may calculate the network reference information according to the measurement gap configuration information transmitted from the first network, and evaluate the performance of the first network according to the network reference information. In response to determining that the performance evaluation result of the first network satisfies the preset condition, the terminal may measure the second network according to the measurement gap configuration information. In response to determining that the performance evaluation result of the first network does not satisfy the preset condition, the terminal may transmit the indication message for updating the measurement gap configuration information to the first network. Thus, rationality of the measurement gap configuration information can be ensured, and influence on data transceiving of the first network due to irrational measurement gap configuration information can be avoided, such that service performance and service continuity of the first network can be ensured.

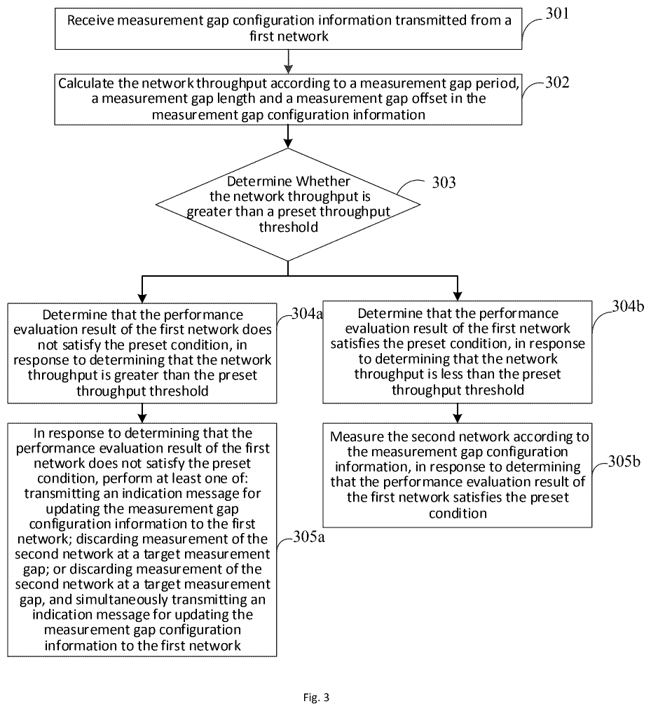

FIG. 3 shows a schematic flow diagram of a method for configuring a measurement gap according to an example of the present disclosure. The method is performed by terminal. Based on the example shown in FIG. 2, as shown in FIG. 3, network reference information may specifically be a network throughput, and the method may include the following step 301 to step 305b.

Step 301, measurement gap configuration information transmitted from a first network is received.

Step 302, the network throughput is calculated according to a measurement gap period, a measurement gap length and a measurement gap offset in the measurement gap configuration information.

According to the example of the present disclosure, for a process of calculating the network throughput, as an example, step 302 includes the following steps: in a case where the measurement gap configuration information includes merely one configuration mode, the network throughput is calculated according to the measurement gap length and the measurement gap period corresponding to the one configuration mode; and in a case where the measurement gap configuration information includes at least two configuration modes, the network reference information is calculated according to the measurement gap period, the measurement gap length and the measurement gap offset in each of the at least two configuration modes.

In some examples, the step that the network throughput is calculated according to the measurement gap length and the measurement gap period corresponding to the one configuration mode includes the following steps: first measurement duration for the second network in the measurement gap period of the one configuration mode is determined according to the measurement gap length corresponding to the one configuration mode; and the network throughput is obtained by dividing the first measurement duration by the measurement gap period of the one configuration mode.

For instance, the measurement gap period of one configuration mode includes two measurement gaps. Lengths of the two measurement gaps are both 0.3 s, and the measurement gap period is 2 s. As the terminal measures the second network in the measurement gap, the first measurement duration for the second network in the measurement gap period may be obtained as 0.3+0.3=0.6 s. Then, the first measurement duration 0.6 s is divided by the measurement gap period 2 s, and the network throughput is obtained as 30%.

In some examples, the step that the network reference information is calculated according to the measurement gap period, the measurement gap length and the measurement gap offset in each of the at least two configuration modes includes the following steps: a maximum measurement gap period is determined according to the measurement gap period in each of the at least two configuration modes; a second measurement duration for the second network in the maximum measurement gap period is determined according to the measurement gap length and the measurement gap offset in each of the at least two configuration modes; and obtaining the network throughput by dividing the second measurement duration by the maximum measurement gap period.

For instance, FIG. 4 shows the measurement gap configuration information with three configuration modes. For each of the configuration modes, MGRP denotes the measurement gap period, MGL denotes the measurement gap length, and offset denotes the measurement gap offset. Specifically, when the network throughput is calculated, the maximum measurement gap period is determined according to the measurement gap period of each of the configuration modes. As shown in FIG. 4, the maximum measurement gap period of three configuration modes is T. Meanwhile, it may be seen from FIG. 4 that measurement time periods for the second network in the maximum measurement gap period T are T1, T2, T3 and T4 respectively. Then, T1, T2, T3 and T4 are added to obtain the second measurement duration for the second network. Finally, the network throughput is calculated as (T1+T2+T3+T4)/T.

Step 303, whether the network throughput is greater than a preset throughput threshold is determined.

In some examples, the method further includes the following step: the preset throughput threshold transmitted by the first network through the RRC message is received; or the preset throughput threshold is obtained based on a protocol. According to the example of the present disclosure, the first network may transmit the measurement gap configuration information and the preset throughput threshold together to the terminal through RRC connection to the terminal. In addition to the mode, the terminal may obtain the preset throughput threshold based on the protocol.

According to the example of the present disclosure, after the network throughput is calculated, the calculated network throughput may be compared with the preset throughput threshold, and the performance evaluation result of the first network may be determined according to a comparison result.

Step 304a, in response to determining that the network throughput is greater than the preset throughput threshold, it is determined that the performance evaluation result of the first network does not satisfy the preset condition.

According to the example of the present disclosure, in response to determining that the calculated network throughput is greater than the preset throughput threshold, it is indicated that a ratio of time for measuring the second network is too great, which may influence the service performance of the first network. In this case, it is determined that the performance evaluation result of the first network does not satisfy the preset condition.

Step 305a, in response to determining that the performance evaluation result of the first network does not satisfy the preset condition, at least one of following steps may be performed: an indication message for updating the measurement gap configuration information is transmitted to the first network; measurement of the second network at a target measurement gap is discarded; or measurement of the second network at a target measurement gap is discarded, and simultaneously an indication message for updating the measurement gap configuration information is transmitted to the first network.

According to the example of the present disclosure, in response to determining that the performance evaluation result of the first network does not satisfy the preset throughput threshold, related operations in step 205, step 206 and step 207 may be performed, and are not repeated here.

Step 304b, in response to determining that the network throughput is less than the preset throughput threshold, it is determined that the performance evaluation result of the first network satisfies the preset condition.

According to the example of the present disclosure, in response to determining that the calculated network throughput is less than the preset throughput threshold, it is indicated that a ratio of time for measuring the second network is rational, which does not influence the service performance of the first network. In this case, it is determined that the performance evaluation result of the first network satisfies the preset condition.

It is to be noted that, in the example of the present disclosure, in response to determining that the network throughput is equal to the preset throughput threshold, it may be considered that the performance evaluation result of the first network does not satisfy the preset condition, or it may be considered that the performance evaluation result of the first network satisfies the preset condition, which may be specifically set according to actual service requirements and is not specifically limited by the example of the present disclosure.

Step 305b, in response to determining that the performance evaluation result of the first network satisfies the preset condition, the second network is measured according to the measurement gap configuration information.

From the process of calculating the network throughput in step 302, it may be understood that the network throughput is actually the ratio of time for measuring the second network. In the example of the present disclosure, when the performance of the first network is evaluated, a ratio of time for transceiving data by the first network may be calculated, besides the ratio of time for measuring the second network. For instance, in FIG. 4, the measurement time periods for the second network in the maximum measurement gap period T are T1, T2, T3 and T4 respectively, and T−(T1+T2+T3+T4) denotes data transceiving time for the first network in the maximum measurement gap period T. Then, [T−(T1+T2+T3+T4)]/T is calculated to obtain the ratio of time for transceiving data by the first network. In response to determining that the ratio of time for transceiving data by the first network is less than a preset threshold, it is determined that the performance evaluation result of the first network does not satisfy the preset condition. In response to determining that the ratio of time for transceiving data by the first network is greater than or equal to a preset threshold, it is determined that the performance evaluation result of the first network satisfies the preset condition.

Through the method for configuring a measurement gap according to the example, the terminal may calculate the network throughput according to the measurement gap configuration information transmitted from the first network, and evaluate the performance of the first network according to the network throughput. In response to determining that the performance evaluation result of the first network satisfies the preset condition, the terminal may measure the second network according to the measurement gap configuration information. In response to determining that the performance evaluation result of the first network does not satisfy the preset condition, the terminal may transmit the indication message for updating the measurement gap configuration information to the first network. Thus, rationality of the measurement gap configuration information can be ensured, and influence on data transceiving of the first network due to irrational measurement gap configuration information can be avoided, such that service performance and service continuity of the first network can be ensured.

FIG. 5 is a schematic flow diagram of a method for configuring a measurement gap according to an example of the present disclosure. As shown in FIG. 5, the method is performed by a first network. The method may include the following steps.

Step 501, measurement gap configuration information is transmitted to a terminal.

The measurement gap configuration information includes a measurement gap period, a measurement gap length, and a measurement gap offset.

According to the example of the present disclosure, the first network may transmit the measurement gap configuration information with one configuration mode, two configuration modes, or more configuration modes to the terminal.

Through the method for configuring a measurement gap according to the example, the measurement gap configuration information may be transmitted to the terminal by the first network. In response to determining that the measurement gap configuration information does not satisfy a measurement condition, the terminal may transmit an indication message for updating the measurement gap configuration information to the first network, such that the first network may update the measurement gap configuration information. Thus, rationality of the measurement gap configuration information can be ensured, and influence on data transceiving of the first network due to irrational measurement gap configuration information can be avoided, such that service performance and service continuity of the first network can be ensured.

FIG. 6 is a schematic flow diagram of a method for configuring a measurement gap according to an example of the present disclosure. The method is performed by a first network. Based on the example shown in FIG. 5, as shown in FIG. 6, the method may include the following steps.

Step 601, measurement gap configuration information is transmitted to a terminal.

Step 602, the measurement gap configuration information is updated, in response to receiving indication message transmitted from the terminal, where indication message is configured for updating the measurement gap configuration information.

The indication message may include a UAI message or an RRC message. The UAI message may include at least one of: an indication of poor signal quality of the current first network or the measurement gap configuration information preferred by the terminal for the second network.

In some examples, the step that the measurement gap configuration information is updated includes at least one of: a measurement gap period in the measurement gap configuration information is extended, or a measurement gap length in the measurement gap configuration information is reduced. According to the example of the present disclosure, in a case where the first network receives the indication message for updating the measurement gap configuration information and fed back by the terminal, it is indicated that the measurement gap information configured by the first network is irrational and needs to be updated. Specifically, the first network may extend the measurement gap period in the measurement gap configuration information or reduce the measurement gap length in the measurement gap configuration information according to at least one of: the indication of poor signal quality or the measurement gap configuration information preferred by the terminal for the second network. Alternatively, the measurement gap period may be extended while the measurement gap length may be reduced. Through the above operations, the ratio of time for measuring the second network, that is, the network throughput, may be reduced, such that the updated measurement gap configuration information can enable the performance of the first network to satisfy the preset condition.

In some examples, the step that the measurement gap configuration information is updated includes the following step: in a case where the measurement gap configuration information includes at least two configuration modes in the indication message, a measurement gap offset in each of the at least two configuration modes of the measurement gap configuration information is aligned. According to the example of the present disclosure, when the measurement gap configuration information is updated, in a case where the measurement gap configuration information with the at least two configuration modes, the measurement gap offset in each of the at least two configuration modes of the measurement configuration information may be aligned. Thus, the time for measuring the second network can be reduced, that is, the network throughput can be reduced.

In some examples, the step that the measurement gap configuration information is updated includes the following step: in a case where the measurement gap configuration information includes at least two configuration modes in the indication message, a number of the at least two configuration modes of the measurement gap configuration information is reduced. According to the example of the present disclosure, in a case where the measurement gap configuration information includes at least two configuration modes, the number of the measurement gap configuration information may be limited by the first network. For instance, the measurement gap configuration information with three configuration modes in the first network. In order to reduce the time for measuring the second network, the measurement gap information with the three configuration modes may be reduced to be the measurement gap information with two configuration modes.

It is to be noted that, for all modes of updating the measurement gap configuration information described above, the first network may merely use one updating mode or simultaneously use a plurality of updating modes, which are not specifically limited by the example of the present disclosure.

Through the method for configuring a measurement gap according to the example, the measurement gap configuration information may be transmitted to the terminal by the first network. In response to determining that the measurement gap configuration information does not satisfy the measurement condition, the terminal may transmit the indication message for updating the measurement gap configuration information to the first network, such that the first network may update the measurement gap configuration information. Thus, rationality of the measurement gap configuration information can be ensured, and influence on data transceiving of the first network due to irrational measurement gap configuration information can be avoided, such that service performance and service continuity of the first network can be ensured.

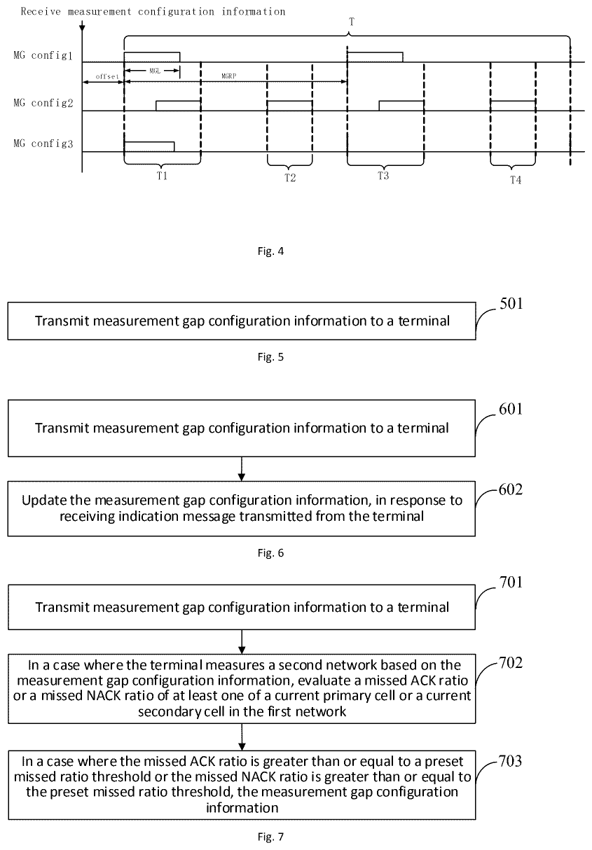

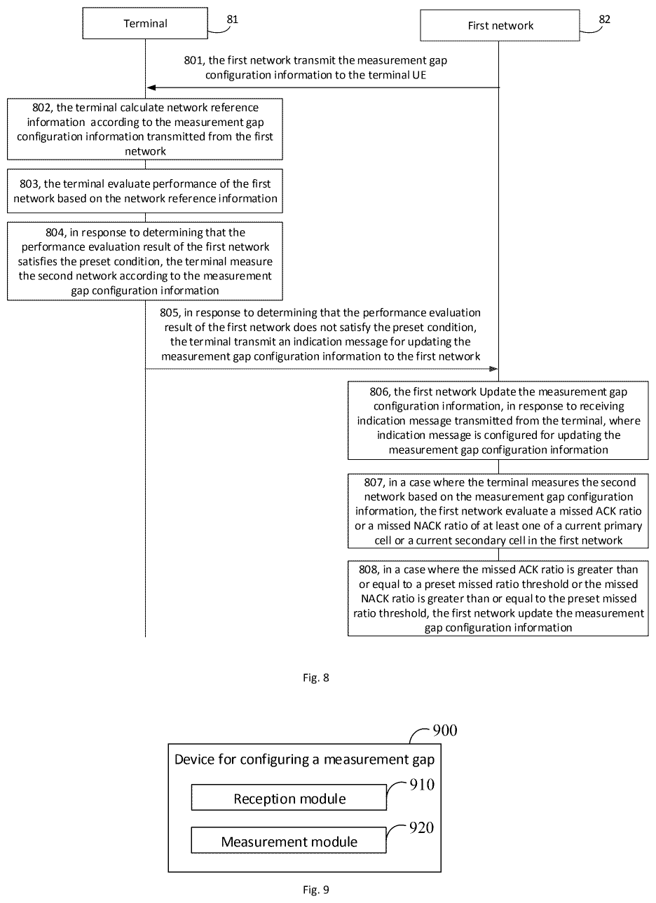

FIG. 7 is a schematic flow diagram of a method for configuring a measurement gap according to an example of the present disclosure. The method is performed by a first network. Based on the example shown in FIG. 5, as shown in FIG. 7, the method may include the following steps.

Step 701, measurement gap configuration information is transmitted to a terminal.

Step 702, in a case where the terminal measures a second network based on the measurement gap configuration information, a missed ACK ratio or a missed NACK ratio of at least one of a current primary cell or a current secondary cell in the first network is evaluated.

In the example of the present disclosure, besides the terminal may evaluate the performance of the first network, the first network may evaluate itself. Specifically, when the terminal measures the second network based on the measurement gap configuration information, the first network may obtain a missed ACK ratio of at least one of a SpCell primary cell or a SCell secondary cell, or the first network may obtain a missed NACK ratio of at least one of a SpCell primary cell or a SCell secondary cell, such that the first network may conduct performance evaluation based on the missed ACK ratio or the missed NACK ratio.

Step 703, in a case where the missed ACK ratio is greater than or equal to a preset missed ratio threshold or the missed NACK ratio is greater than or equal to the preset missed ratio threshold, the measurement gap configuration information is updated.

According to the example of the present disclosure, in a case where the missed ACK ratio of at least one of a primary cell or a secondary cell is greater than or equal to a preset missed ratio threshold, or the missed NACK ratio of at least one of a primary cell or a secondary cell is greater than or equal to the preset missed ratio threshold, it is indicated that the performance evaluation result of the first network does not satisfy the preset condition, and the measurement gap configuration information needs to be updated. In a case where the missed ACK ratio of at least one of a primary cell or a secondary cell is less than a preset missed ratio threshold, or the missed NACK ratio of at least one of a primary cell or a secondary cell is less than the preset missed ratio threshold, it is indicated that the performance evaluation result of the first network satisfies the preset condition, and the measurement gap configuration information does not need to be updated.

It is to be noted that the preset missed ratio threshold is related to configuration information of a discontinuous reception (DRX) mechanism of the first network. In a case where configuration information of the DRX mechanism is different, the preset missed ratio threshold may be different. In addition, the preset missed ratio threshold is also related to a measurement period of an inactive secondary cell (measCycleSCell). In a case where the inactive secondary cell exists in the first network and the measurement period of the inactive secondary cell (measCycleSCell) is different, the preset missed ratio threshold may be different.

Through the method for configuring a measurement gap according to the example, when the terminal measures the second network based on the measurement gap configuration information, the first network may obtain a missed ACK ratio or a missed NACK ratio of at least one of a current primary cell or a current secondary cell, and conduct performance evaluation by itself according to the missed ACK ratio or the missed NACK ratio. In a case where the performance evaluation result does not satisfy the preset condition, the measurement gap configuration information is automatically updated. Thus, rationality of the measurement gap configuration information can be ensured, and influence on data transceiving of the first network due to irrational measurement gap configuration information can be avoided, such that service performance and service continuity of the first network can be ensured.

FIG. 8 is a sequence diagram of a method for configuring a measurement gap according to an example of the present disclosure. The method is performed by a system for configuring a measurement gap. The system includes: terminal and a first network. Measurement gap configuration information is transmitted to the terminal by the first network. The measurement gap configuration information transmitted from the first network is received by the terminal. In response to satisfying a preset measurement condition, a second network is measured according to the measurement gap configuration information.

With reference to FIG. 8, the method includes the following step 801 to step 808.

Step 801, the measurement gap configuration information is transmitted to the terminal 81 by the first network 82.

Step 802, network reference information is calculated by the terminal 81 according to the measurement gap configuration information transmitted from the first network 82.

In the example of the present disclosure, a network throughput may be calculated according to a measurement gap period, a measurement gap length and a measurement gap offset in the measurement gap configuration information. Specifically, in a case where the measurement gap configuration information includes merely one configuration mode, the network throughput is calculated according to the measurement gap length and the measurement gap period corresponding to the one configuration mode; and in a case where the measurement gap configuration information includes at least two configuration modes, the network reference information is calculated according to the measurement gap period, the measurement gap length and the measurement gap offset in each of the at least two configuration modes.

For one configuration mode, a first measurement duration for the second network in the measurement gap period of the one configuration mode may be determined according to the measurement gap length corresponding to the one configuration mode; and the network throughput may be obtained by dividing the first measurement duration by the measurement gap period of the one configuration mode. For two configuration modes, a maximum measurement gap period may be determined according to the measurement gap period in each of the at least two configuration modes; a second measurement duration for the second network in the maximum measurement gap period may be determined according to the measurement gap length and the measurement gap offset in each of the at least two configuration modes; and the network throughput may be obtained by dividing the second measurement duration by the maximum measurement gap period.

Step 803, performance of the first network 82 is evaluated by the terminal 81 based on the network reference information.

In the example of the present disclosure, during performance evaluation, whether the network throughput is greater than a preset throughput threshold needs to be determined. In response to determining that the network throughput is greater than the preset throughput threshold, it is determined that the performance evaluation result of the first network 82 does not satisfy the preset condition. In response to determining that the network throughput is less than the preset throughput threshold, it is determined that the performance evaluation result of the first network 82 satisfies the preset condition.

Step 804, in response to determining that the performance evaluation result of the first network 82 satisfies the preset condition, the second network is measured by the terminal 81 according to the measurement gap configuration information.

Step 805, in response to determining that the performance evaluation result of the first network 82 does not satisfy the preset condition, an indication message for updating the measurement gap configuration information is transmitted to the first network 82 by the terminal 81.

Step 806, the measurement gap configuration information is updated by the first network 82, in response to receiving indication message transmitted from the terminal 81, where indication message is configured for updating the measurement gap configuration information.

Specifically, during updating, at least one of the following may be performed: a measurement gap period in the measurement gap configuration information may be extended, or a measurement gap length in the measurement gap configuration information may be reduced. In a case where the measurement gap configuration information includes at least two configuration modes in the indication message, a measurement gap offset in each of the at least two configuration modes of the measurement gap configuration information may be aligned, or a number of the at least two configuration modes of the measurement gap configuration information may be reduced.

Step 807, in a case where the terminal 81 measures the second network based on the measurement gap configuration information, a missed ACK ratio or a missed NACK ratio of at least one of a current primary cell or a current secondary cell in the first network 82 is evaluated by the first network 82.

Step 808, in a case where the missed ACK ratio is greater than or equal to a preset missed ratio threshold or the missed NACK ratio is greater than or equal to the preset missed ratio threshold, the measurement gap configuration information is updated by the first network 82.

Through the method for configuring a measurement gap according to the example, the terminal may calculate the network throughput according to the measurement gap configuration information transmitted from the first network, and evaluate the performance of the first network according to the network throughput. In response to determining that the performance evaluation result of the first network satisfies the preset condition, the terminal may measure the second network according to the measurement gap configuration information. In response to determining that the performance evaluation result of the first network does not satisfy the preset condition, the terminal may transmit the indication message for updating the measurement gap configuration information to the first network. Thus, rationality of the measurement gap configuration information can be ensured, and influence on data transceiving of the first network due to irrational measurement gap configuration information can be avoided, such that service performance and service continuity of the first network can be ensured.

In the example according to the present disclosure, the method according to the example of the present disclosure is introduced in terms of a first network and terminal separately. In order to achieve functions of the method according to the example of the present disclosure, the first network and the terminal may include hardware structures and software modules. The above functions are achieved in a form of the hardware structure, the software module, or a combination of the hardware structure and the software module. One of the above functions may be performed by a hardware structure, a software module, or a combination of a hardware structure and a software module.

Corresponding to the method for configuring a measurement gap according to the above examples, the present disclosure further provides a device for configuring a measurement gap. Since the device for configuring a measurement gap according to the example of the present disclosure corresponds to the method for configuring a measurement gap according to the above examples, the embodiments of the method for configuring a measurement gap are also applicable to the device for configuring a measurement gap according to the example, which will not be described in detail in the example.

FIG. 9 is a schematic structural diagram of a device for configuring a measurement gap according to an example of the present disclosure. The device for configuring a measurement gap 900 may be applied to terminal.

As shown in FIG. 9, the device for configuring a measurement gap 900 may include: a reception module 910 configured to receive measurement gap configuration information transmitted from a first network; and a measurement module 920 configured to measure, in response to satisfying a preset measurement condition, a second network according to the measurement gap configuration information.

In some examples, the device further includes: a calculation module and an evaluation module. The calculation module is configured to calculate network reference information according to the measurement gap configuration information. The evaluation module is configured to evaluate performance of the first network based on the network reference information.

In some examples, the measurement module 920 is specifically configured to measure, in response to determining that a performance evaluation result of the first network satisfies a preset condition, the second network according to the measurement gap configuration information.

In some examples, the device further includes: a transmission module configured to perform at least one of: transmitting, in response to determining that a performance evaluation result of the first network does not satisfy a preset condition, an indication message for updating the measurement gap configuration information to the first network; discarding, in response to determining that the performance evaluation result of the first network does not satisfy the preset condition, measurement of the second network at a target measurement gap; or; discarding measurement of the second network at a target measurement gap, and simultaneously transmitting an indication message for updating the measurement gap configuration information to the first network, in response to determining that the performance evaluation result of the first network does not satisfy a preset condition.

In some examples, the indication message includes a UAI message or an RRC message.

In some examples, the network reference information is a network throughput.

In some examples, the calculation module is specifically configured to calculate the network throughput according to a measurement gap period, a measurement gap length and a measurement gap offset in the measurement gap configuration information.

In some examples, the evaluation module is specifically configured to determine whether the network throughput is greater than a preset throughput threshold; determine, in response to determining that the network throughput is greater than the preset throughput threshold, that the performance evaluation result of the first network does not satisfy the preset condition; and determine, in response to determining that the network throughput is less than the preset throughput threshold, that the performance evaluation result of the first network satisfies the preset condition.

In some examples, the calculation module is further specifically configured to calculate, in a case where the measurement gap configuration information includes merely one configuration mode, the network throughput according to the measurement gap length and the measurement gap period corresponding to the one configuration mode; and calculate, in a case where the measurement gap configuration information includes at least two configuration modes, the network reference information according to the measurement gap period, the measurement gap length and the measurement gap offset in each of the at least two configuration modes.

In some examples, the calculation module is further specifically configured to determine a first measurement duration for the second network in the measurement gap period of the one configuration mode according to the measurement gap length corresponding to the one configuration mode; and obtain the network throughput by dividing the first measurement duration by the measurement gap period of the one configuration mode, and.

In some examples, the calculation module is further specifically configured to determine a maximum measurement gap period according to the measurement gap period in each of the at least two configuration modes; determine a second measurement duration for the second network in the maximum measurement gap period according to the measurement gap length and the measurement gap offset in each of the at least two configuration modes; and obtain the network throughput by dividing the second measurement duration by the maximum measurement gap period.

In some examples, the reception module 910 is further configured to receive the preset throughput threshold transmitted by the first network through the RRC message; or obtain the preset throughput threshold based on a protocol.

In some examples, the terminal is MUSIM type terminal.

Through the example, the terminal may calculate the network throughput according to the measurement gap configuration information transmitted from the first network, and evaluate the performance of the first network according to the network throughput. In response to determining that the performance evaluation result of the first network satisfies the preset condition, the terminal may measure the second network according to the measurement gap configuration information. In response to determining that the performance evaluation result of the first network does not satisfy the preset condition, the terminal may transmit the indication message for updating the measurement gap configuration information to the first network. Thus, rationality of the measurement gap configuration information can be ensured, and influence on data transceiving of the first network due to irrational measurement gap configuration information can be avoided, such that service performance and service continuity of the first network can be ensured.

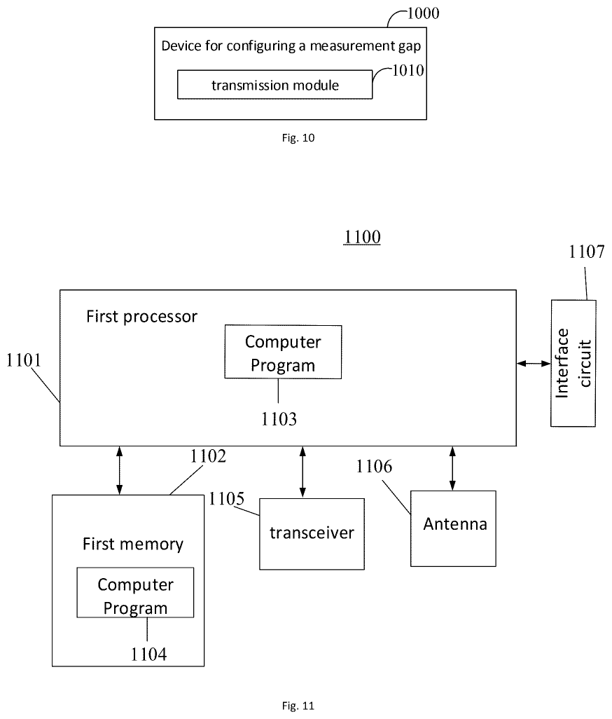

FIG. 10 is a schematic structural diagram of a device for configuring a measurement gap according to an example of the present disclosure. The device for configuring a measurement gap 1000 may be applied to a first network.

As shown in FIG. 10, the device for configuring a measurement gap 1000 may include: a transmission module 1010 configured to transmit measurement gap configuration information to a terminal.

In some examples, the device further includes an updating module. The updating module is configured to update the measurement gap configuration information, in response to receiving indication message transmitted from the terminal, where the indication message is configured for updating the measurement gap configuration information.

In some examples, the updating module is specifically configured to at least one of: extend a measurement gap period in the measurement gap configuration information, or reduce a measurement gap length in the measurement gap configuration information.

In some examples, the updating module is further specifically configured to align, in a case where the measurement gap configuration information includes at least two configuration modes in the indication message, a measurement gap offset in each of the at least two configuration modes of the measurement gap configuration information.

In some examples, the updating module is further specifically configured to reduce, in a case where the measurement gap configuration information includes at least two configuration modes in the indication message, a number of the at least two configuration modes of the measurement gap configuration information.

In some examples, the device further includes an evaluation module. The evaluation module is configured to evaluate, in a case where the terminal measures a second network based on the measurement gap configuration information, a missed ACK ratio or a missed NACK ratio of at least one of a current primary cell or a current secondary cell in the first network.

The updating module is further configured to update, in a case where the missed ACK ratio is greater than or equal to a preset missed ratio threshold or the missed NACK ratio is greater than or equal to the preset missed ratio threshold, the measurement gap configuration information.

Through the example, the measurement gap configuration information may be transmitted to the terminal by the first network. In response to determining that the measurement gap configuration information does not satisfy the measurement condition, the terminal may transmit the indication message for updating the measurement gap configuration information to the first network, such that the first network may update the measurement gap configuration information. Thus, rationality of the measurement gap configuration information can be ensured, and influence on data transceiving of the first network due to irrational measurement gap configuration information can be avoided, such that service performance and service continuity of the first network can be ensured.

With reference to FIG. 11, FIG. 11 is a schematic structural diagram of a communication device 1100 according to the example. The communication device 1100 may be a network device, a terminal, a chip, a chip system or a processor that enables a network device to implement the above method, or a chip, a chip system or a processor that enables a terminal to implement the above method. The device may be configured to implement the method described in the above method example. Reference may be made to the description in the above method example for details.

The communication device 1100 may include one or more first processors 1101. The first processor 1101 may be a general-purpose processor, a special-purpose processor, etc. For instance, the processor may be a baseband processor or a central processing unit. The baseband processor may be configured to process a communication protocol and communication data. The central processing unit may be configured to control the communication device (for instance, a base station, a baseband chip, a terminal device, a terminal device chip, a distributed unit (DU), or a centralized unit (CU)), execute a computer program, and process data of the computer program.

In some examples, the communication device 1100 may further include one or more first memories 1102. The memory may store a computer program 1104. The first processor 1101 executes the computer program 1104, such that the communication device 1100 performs the method described in the above method example. In some examples, the first memory 1102 may further store data. The communication device 1100 and the first memory 1102 may be arranged separately or integrated with each other.

In some examples, the communication device 1100 may further include a transceiver 1105 and an antenna 1106. The transceiver 1105 may be referred to as a transceiving unit, a transceiving machine, a transceiving circuit, etc., and is configured to achieve a transceiving function. The transceiver 1105 may include a receiver and a transmitter. The receiver may be referred to as a reception machine or a reception circuit, and is configured to achieve a reception function. The transmitter may be referred to as a transmission machine or a transmission circuit, and is configured to achieve a transmission function.

In some examples, the communication device 1100 may further include one or more interface circuits 1107. The interface circuit 1107 is configured to receive a code instruction and transmit the code instruction to the first processor 1101. The first processor 1101 runs the code instruction, such that the method described in the above method example is executed by the communication device 1100.

In one implementation, the first processor 1101 may include the transceiver configured to achieve reception and transmission functions. For instance, the transceiver may be a transceiving circuit, an interface, or an interface circuit. The transceiving circuit, interface or interface circuit configured to achieve the reception and transmission functions may be separated or integrated. The transceiving circuit, interface or interface circuit may be configured to read and write codes/data. Alternatively, the transceiving circuit, interface or interface circuit may be configured to transmit or transfer a signal.

In one implementation, the first processor 1101 may store a computer program 1103. The computer program 1103 runs on the first processor 1101, such that the communication device 1100 may execute the method described in the above method example. The computer program 1103 may be cured in the first processor 1101. In this case, the first processor 1101 may be implemented by hardware.

In one implementation, the communication device 1100 may include a circuit. The circuit may achieve the transmission or reception or communication function in the above method example. The processor and transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured by means of various IC process technologies, such as a complementary metal oxide semiconductor (CMOS), an n-metal oxide semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication device according to the above examples may be the network device or the user equipment, which does not limit the scope of the communication device according to the present disclosure. A structure of the communication device may not be limited by FIG. 11. The communication device may be an independent device or may be part of a large device. For instance, the communication device may be:
(1) an independent integrated circuit (IC), a chip, a chip system, or a subsystem;
(2) a set having one or more ICs, where the IC set may also include a storage component configured to store data and a computer program;
(3) an ASIC, for instance, a modem;
(4) a module that may be embedded in other devices;
(5) a receiver, a terminal device, an intelligent terminal device, a cellular phone, a radio device, a handset, a mobile unit, an in-vehicle device, a network device, a cloud device, an artificial intelligence device, etc.; and
(6) other devices.

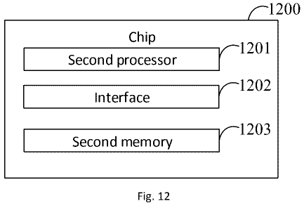

In a case where the communication device may be a chip or a chip system, reference may be made to a schematic structural diagram of the chip shown in FIG. 12. The chip 1200 shown in FIG. 12 includes a second processor 1201 and an interface 1202. The number of second processors 1201 may be one or more. The number of interfaces 1202 may be greater than one.

In some examples, the chip 1200 further includes a second memory 1203. The second memory 1203 is configured to store a computer program and data that are necessary.

Those skilled in the art may further understand that various illustrative logical blocks and steps listed in the examples of the present disclosure may be implemented by electronic hardware, computer software, or a combination of both. Whether the function is achieved by hardware or software depends on specific applications and design requirements of an entire system. Those skilled in the art may use different methods to achieve the above functions for each particular application, but such implementation is not considered to fall beyond the protection scope of the examples of the present disclosure.

The present disclosure further provides a readable storage medium. The readable storage medium stores an instruction. When the instruction is executed by a computer, functions of any one of the above method examples are achieved.

The present disclosure further provides a computer program product. When the computer program product is executed by a computer, functions of any one of the above method examples are achieved.

The above examples may be partially or completely implemented with software, hardware, firmware or their any combinations. When implemented with software, the examples may be partially or completely implemented in a form of a computer program product. The computer program product includes one or more computer programs. When a computer program is loaded and executed on a computer, a flow or functions according to the example of the present disclosure is partially or completely generated. The computer may be a general-purpose computer, a special-purpose computer, a computer network, or another programmable device. The computer program may be stored in a computer-readable storage medium or transmitted from a computer-readable storage medium to another computer-readable storage medium. For instance, the computer program may be transmitted from a website, a computer, a server or a data center to another website, another computer, another server or another data center through wired means (for instance, a coaxial cable, an optical fiber, or a digital subscriber line (DSL)) or through radio means (for instance, infrared waves, radio, or microwaves). The computer-readable storage medium may be any available medium that may be accessed by the computer or a data storage device such as a server and a data center that includes one or more available media integrated. The available medium may be a magnetic medium (for instance, a floppy disk, a hard disk, or a magnetic tape), an optical medium (for instance, a high-density digital video disc (DVD)), a semiconductor medium (for instance, a solid state disk (SSD)), etc.

Those of ordinary skill in the art may understand that numerical symbols such as “first” and “second” involved in the present disclosure are merely for convenience of description, instead of limiting the scope of the examples of the present disclosure, and further indicate a sequence.

“At least one” in the present disclosure may also be described as “one or more”, and “a plurality of” may indicate two, three, four or more, which are not limited by the present disclosure. In the example of the present disclosure, for a technical feature, technical features in the technical feature are distinguished by “first”, “second”, “third”, “A”, “B”, “C”, “D”, etc. The technical features described by the “first”, “second”, “third”, “A”, “B”, “C” and “D” are not in order of succession or order of size.

As used here, the terms “machine-readable medium” and “computer-readable medium” refer to any computer program product, device, and/or device (for instance, a magnetic disk, an optical disk, a memory, a programmable logic device (PLD)) configured to provide a machine instruction and/or data for a programmable processor, including a machine-readable medium receiving a machine instruction as a machine-readable signal. The term “machine-readable signal” refers to any signal configured to provide a machine instruction and/or data for a programmable processor.

The systems and technologies described here may be implemented in a computation system (for instance, a data server) including a background component, or a computation system (for instance, an application server) including a middleware component, or a computation system (for instance, a user computer having a graphical user interface or a web browser through which a user may interact with the embodiments of the systems and technologies described here) including a front-end component, or a computation system including any combination of such background components, middleware components, or front-end components. The components of the system may be connected to each other through digital data communication (for example, a communication network) in any form or through any medium. Instances of the communication network include: a local area network (LAN), a wide area network (WAN), and the Internet.

A computer system may include a client and a server. The client and the server are generally far away from each other and typically interact with each other through a communication network. A relation between the client and the server is generated by computer programs operating on corresponding computers and having a client-server relation with each other.

It is to be understood that the steps may be reordered, added or deleted by using the various flows illustrated above. For instance, the steps described in the present disclosure may be executed concurrently, sequentially or in a different order, so long as the desired results of the technical solutions disclosed in the present disclosure can be achieved, which is not limited here.

In addition, it is to be understood that various examples described in the present disclosure may be implemented separately or in combination with other examples under permission of the solution.

Those of ordinary skill in the art may understand that the units and algorithm steps of the instances described in connection with the examples disclosed here may be implemented in electronic hardware, or a combination of computer software and electronic hardware. Whether the functions are executed in hardware or software depends on specific application and design constraints of the technical solution. Professionals may use different methods to implement the described functions for each specific application, but such implementation should not be considered to fall beyond the scope of the present disclosure.

Those skilled in the art may clearly understand that, for the convenience and conciseness of description, reference may be made to a corresponding process in the above method example for a specific operation process of the system, device and unit described above, which will not be repeated here.

What are described above are merely specific embodiments of the present disclosure, and are not intended to limit the protection scope of the present disclosure. Any changes or substitutions that may be easily made by those skilled in the art within the technical scope disclosed in the present disclosure should fall within the protection scope of the present disclosure. Thus, the protection scope of the present disclosure should be subject to the protection scope of the claims.

1. A method for configuring a measurement gap, performed by a terminal, the method comprising:
receiving measurement gap configuration information transmitted from a first network; and
measuring, in response to satisfying a preset measurement condition, a second network according to the measurement gap configuration information.

2. The method according to claim 1, further comprising:
calculating network reference information according to the measurement gap configuration information; and
evaluating performance of the first network based on the network reference information.

3. The method according to claim 2, wherein measuring, in response to satisfying the preset measurement condition, the second network according to the measurement gap configuration information comprises:
measuring, in response to determining that a performance evaluation result of the first network satisfies a preset condition, the second network according to the measurement gap configuration information.

4. The method according to claim 2, wherein the method further comprises at least one of the following:
transmitting, in response to determining that a performance evaluation result of the first network does not satisfy a preset condition, an indication message for updating the measurement gap configuration information to the first network;
discarding, in response to determining that the performance evaluation result of the first network does not satisfy the preset condition, measurement of the second network at a target measurement gap; or
discarding measurement of the second network at a target measurement gap and simultaneously transmitting an indication message for updating the measurement gap configuration information to the first network, in response to determining that the performance evaluation result of the first network does not satisfy the preset condition.

5. (canceled)

6. The method according to claim 2, wherein the network reference information is a network throughput.

7. The method according to claim 6, wherein calculating the network reference information according to the measurement gap configuration information comprises:
calculating the network throughput according to a measurement gap period, a measurement gap length and a measurement gap offset in the measurement gap configuration information.

8. The method according to claim 7, wherein evaluating performance of the first network based on the network reference information comprises:
determining whether the network throughput is greater than a preset throughput threshold;
determining that a performance evaluation result of the first network does not satisfy a preset condition, in response to determining that the network throughput is greater than the preset throughput threshold; and
determining that the performance evaluation result of the first network satisfies the preset condition in response to determining that the network throughput is less than the preset throughput threshold.

9. The method according to claim 7, wherein calculating the network throughput according to the measurement gap period, the measurement gap length and the measurement gap offset in the measurement gap configuration information comprises:
calculating, in a case where the measurement gap configuration information comprises one configuration mode, the network throughput according to the measurement gap length and the measurement gap period corresponding to the one configuration mode; and
calculating, in a case where the measurement gap configuration information comprises at least two configuration modes, the network reference information according to the measurement gap period, the measurement gap length and the measurement gap offset in each of the at least two configuration modes.

10. The method according to claim 9, wherein calculating the network throughput according to the measurement gap length and the measurement gap period corresponding to the one configuration mode comprises:
determining a first measurement duration for the second network in the measurement gap period of the one configuration mode according to the measurement gap length corresponding to the one configuration mode; and
obtaining the network throughput by dividing the first measurement duration by the measurement gap period of the one configuration mode.

11. The method according to claim 9, wherein calculating the network reference information according to the measurement gap period, the measurement gap length and the measurement gap offset in each of the at least two configuration modes comprises:
determining a maximum measurement gap period according to the measurement gap period in each of the at least two configuration modes;
determining a second measurement duration for the second network in the maximum measurement gap period according to the measurement gap length and the measurement gap offset in each of the at least two configuration modes; and
obtaining the network throughput by dividing the second measurement duration by the maximum measurement gap period.

12. The method according to claim 8, further comprising:
receiving the preset throughput threshold transmitted by the first network through an RRC message; or
obtaining the preset throughput threshold based on a protocol.

13. (canceled)

14. A method for configuring a measurement gap, performed by a first network, the method comprising:
transmitting measurement gap configuration information to a terminal.

15. The method according to claim 14, further comprising:
updating the measurement gap configuration information in response to receiving an indication message transmitted from the terminal, wherein the indication message is configured for updating the measurement gap configuration information.

16. The method according to claim 15, wherein updating the measurement gap configuration information comprises at least one of the following:
extending a measurement gap period in the measurement gap configuration information; or
reducing a measurement gap length in the measurement gap configuration information.

17. The method according to claim 15, wherein updating the measurement gap configuration information comprises:
aligning, in a case where the measurement gap configuration information comprises at least two configuration modes in the indication message, a measurement gap offset in each of the at least two configuration modes of the measurement gap configuration information.

18. The method according to claim 15, wherein updating the measurement gap configuration information comprises:
reducing, in a case where the measurement gap configuration information comprises at least two configuration modes in the indication message, a number of the at least two configuration modes of the measurement gap configuration information.

19. The method according to claim 14, further comprising:
evaluating, in a case where the terminal measures a second network based on the measurement gap configuration information, a missed ACK ratio or a missed NACK ratio of at least one of a current primary cell or a current secondary cell in the first network; and
updating, in a case where the missed ACK ratio is greater than or equal to a preset missed ratio threshold or the missed NACK ratio is greater than or equal to the preset missed ratio threshold, the measurement gap configuration information.

20-21. (canceled)

22. A system for configuring a measurement gap, comprising: a terminal and a first network, wherein
the first network transmits measurement gap configuration information to the terminal; and
the terminal receives the measurement gap configuration information transmitted from the first network and measure a second network according to the measurement gap configuration information in a case where a preset measurement condition is satisfied.

23. A communication device, comprising: a transceiver, a memory, and a processor connected to the transceiver and the memory separately, wherein the processor is configured to control the transceiver to transceive radio signals by executing computer-executable instructions in the memory to implement the method according to claim 1.

24. A non-transitory computer storage medium storing computer-executable instructions, wherein the computer-executable instructions, when executed by a processor, cause the processor to implement the method according to claim 1.
